(19) United States
(12) Patent Application Publication
(10) Pub. No.: US 2025/0267093 A1
(43) Pub. Date: Aug. 21, 2025

(54) DATA TRANSMISSION METHOD AND APPARATUS, TERMINAL, NETWORK SIDE DEVICE, AND SYSTEM

(71) Applicant: VIVO MOBILE COMMUNICATION CO., LTD., Dongguan (CN)

(72) Inventors: Jiamin LIU, Dongguan (CN); Xiaodong YANG, Dongguan (CN)

(73) Assignee: VIVO MOBILE COMMUNICATION CO., LTD., Dongguan (CN)

(21) Appl. No.: 19/203,158

(22) Filed: May 8, 2025

Related U.S. Application Data
(63) Continuation of application No. PCT/CN2023/126756, filed on Oct. 26, 2023.

(30) Foreign Application Priority Data
Nov. 9, 2022 (CN) 202211399198.6

(51) Int. Cl. H04L 45/24; H04W 88/04

(52) U.S. Cl. CPC H04L 45/24; H04W 88/04

(57) ABSTRACT

A data transmission method and apparatus, a terminal, a network side device, and a system are provided. The data transmission method includes: A first terminal receives or generates configuration information of multi-path low-layer aggregation transmission, where the multi-path low-layer aggregation transmission includes multi-path MAC layer aggregation transmission or multi-path PHY layer aggregation transmission. The first terminal performs the multi-path low-layer aggregation transmission based on the configuration information of multi-path low-layer aggregation transmission.

### CROSS-REFERENCE TO RELATED APPLICATIONS

This application is a continuation of International Application No. PCT/CN2023/126756, filed Oct. 26, 2023, which claims priority to Chinese Patent Application No. 202211399198.6, filed Nov. 9, 2022. The entire contents of each of the above-referenced applications are expressly incorporated herein by reference.

### TECHNICAL FIELD

This application pertains to the field of communication technologies, and in particular, to a data transmission method and apparatus, a terminal, a network side device, and a system.

### BACKGROUND

A direct link refers to a wireless link on which a UE performs data transmission with a base station via a Uu air interface of the UE, and is mainly used for data transmission between the UE and the base station. An SL relay (SideLink relay) refers to a wireless link on which UEs perform data transmission via a sidelink (PC5) interface, and is mainly used for data transmission between the UEs.

Currently, existing technical solutions only support single-path communication via an SL relay or a direct link, resulting in poor transmission effects in terms of reliability, a delay, a throughput, and the like of data transmission.

### SUMMARY

Embodiments of this application provide a data transmission method and apparatus, a terminal, a network side device, and a system, to improve data transmission effects.

According to a first aspect, a data transmission method is provided. The method includes:

A first terminal receives or generates configuration information of multi-path low-layer aggregation transmission, where the multi-path low-layer aggregation transmission includes multi-path MAC layer aggregation transmission and/or multi-path PHY layer aggregation transmission.

The first terminal performs multi-path low-layer aggregation transmission based on the configuration information of multi-path low-layer aggregation transmission.

According to a second aspect, a data transmission method is provided. The method includes:

A second terminal receives or generates configuration information of multi-path low-layer aggregation transmission, where the multi-path low-layer aggregation transmission includes multi-path MAC layer aggregation transmission and/or multi-path PHY layer aggregation transmission.

The second terminal performs multi-path low-layer aggregation transmission based on the configuration information of multi-path low-layer aggregation transmission.

The second terminal is a relay terminal between a first terminal and a network side device, or the second terminal is a relay terminal between the first terminal and a third terminal.

According to a third aspect, a data transmission method is provided. The method includes:

A network side device sends configuration information of multi-path low-layer aggregation transmission, where the multi-path low-layer aggregation transmission includes multi-path MAC layer aggregation transmission and/or multi-path PHY layer aggregation transmission.

The network side device combines different received data, and/or deletes duplicated received data.

According to a fourth aspect, a data transmission apparatus is provided. The apparatus is applied to a first terminal, and includes:
a first processing module, configured to receive or generate configuration information of multi-path low-layer aggregation transmission, where the multi-path low-layer aggregation transmission includes multi-path MAC layer aggregation transmission and/or multi-path PHY layer aggregation transmission; and
a first transmission module, configured to perform multi-path low-layer aggregation transmission based on the configuration information of multi-path low-layer aggregation transmission.

According to a fifth aspect, a data transmission apparatus is provided. The apparatus is applied to a second terminal, where the second terminal is a relay terminal between a first terminal and a network side device, or the second terminal is a relay terminal between the first terminal and a third terminal; and the apparatus includes:
a second processing module, configured to receive or generate configuration information of multi-path low-layer aggregation transmission, where the multi-path low-layer aggregation transmission includes multi-path MAC layer aggregation transmission and/or multi-path PHY layer aggregation transmission; and
a second transmission module, configured to perform multi-path low-layer aggregation transmission based on the configuration information of multi-path low-layer aggregation transmission.

According to a sixth aspect, a data transmission apparatus is provided. The apparatus is applied to a network side device, and includes:
a sending module, configured to send configuration information of multi-path low-layer aggregation transmission, where the multi-path low-layer aggregation transmission includes multi-path MAC layer aggregation transmission and/or multi-path PHY layer aggregation transmission; and
a processing module, configured to: combine different received data, and/or delete duplicated received data.

According to a seventh aspect, a terminal is provided. The terminal includes a processor and a memory. The memory stores a program or instructions that can be run on the processor. When the program or the instructions are executed by the processor, the steps of the data transmission method according to the first aspect or the second aspect are implemented.

According to an eighth aspect, a network side device is provided. The network side device includes a processor and a memory. The memory stores a program or instructions that can be run on the processor. When the program or the instructions are executed by the processor, the steps of the data transmission method according to the third aspect are implemented.

According to a ninth aspect, a data transmission system is provided. The system includes a first terminal and a second terminal. The first terminal is configured to perform the steps of the data transmission method according to the first aspect, the second terminal is configured to perform the steps of the data transmission method according to the second aspect, and a network side device is configured to perform the steps of the data transmission method according to the third aspect.

According to a tenth aspect, a readable storage medium is provided. The readable storage medium stores a program or instructions. When the program or the instructions are executed by a processor, the steps of the data transmission method according to the first aspect are implemented, the steps of the data transmission method according to the second aspect are implemented, or the steps of the data transmission method according to the third aspect are implemented.

According to an eleventh aspect, a chip is provided. The chip includes a processor and a communication interface. The communication interface is coupled to the processor. The processor is configured to run a program or instructions, to implement the steps of the data transmission method according to the first aspect, the steps of the data transmission method according to the second aspect, or the steps of the data transmission method according to the third aspect.

According to a twelfth aspect, a computer program/program product is provided.

The computer program/program product is stored in a storage medium. The computer program/program product is executed by at least one processor, to implement the steps of the data transmission method according to the first aspect, the steps of the data transmission method according to the second aspect, or the steps of the data transmission method according to the third aspect.

In the embodiments of this application, the first terminal performs multi-path MAC layer aggregation transmission and/or multi-path PHY layer aggregation transmission based on the configuration information of multi-path low-layer aggregation transmission that is received or generated by the first terminal, to perform multi-path joint data transmission with a peer end at a granularity of a low-layer data unit, so that transmission effects in terms of reliability, a delay, a throughput, and the like of data transmission can be improved.

### BRIEF DESCRIPTION OF DRAWINGS

To describe embodiments of this application more clearly, the following briefly describes accompanying drawings for describing the embodiments. Clearly, the accompanying drawings in the following descriptions show merely some embodiments of this application, and a person of ordinary skill in the art may derive other drawings from these accompanying drawings without creative efforts.

FIG. 1 is a block diagram of a wireless communication system to which embodiments of this application are applicable;

FIG. 2 is a flowchart of a data transmission method according to an embodiment of this application;

FIG. 3 is a schematic diagram of a data transmission scenario according to an embodiment of this application;

FIG. 4 is a schematic diagram of another data transmission scenario according to an embodiment of this application;

FIG. 5 is a schematic diagram of a protocol stack architecture according to an embodiment of this application;

FIG. 6 is a flowchart of another data transmission method according to an embodiment of this application;

FIG. 7 is a flowchart of another data transmission method according to an embodiment of this application;

FIG. 8 is a schematic diagram of a structure of a data transmission apparatus according to an embodiment of this application;

FIG. 9 is a schematic diagram of a structure of another data transmission apparatus according to an embodiment of this application;

FIG. 10 is a schematic diagram of a structure of another data transmission apparatus according to an embodiment of this application;

FIG. 11 is a schematic diagram of a structure of a communication device according to an embodiment of this application;

FIG. 12 is a schematic diagram of a hardware structure of a terminal according to an embodiment of this application;

FIG. 13 is a schematic diagram of a structure of a terminal according to an embodiment of this application; and

FIG. 14 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), and Single-carrier Frequency Division Multiple Access (SC-FDMA). The terms “system” and “network” in the embodiments of this application may be used interchangeably. The technologies described can be applied to both the systems and the radio technologies mentioned above as well as to other systems and radio technologies. A New Radio (NR) system is described in the following descriptions for illustrative purposes, and the NR terminology is used in most of the following descriptions, although these technologies can also be applied to systems other than the NR system, such as a 6^{th} Generation (6G) communication system.

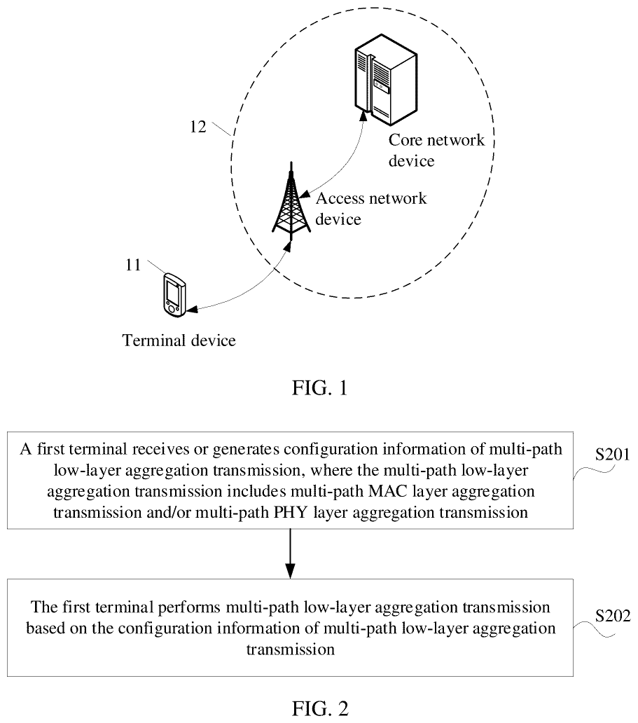

FIG. 1 is a block diagram of a wireless communication system to which embodiments of this application are applicable. The wireless communication system includes a terminal device 11 and a network side device 12. The terminal device 11 may be a terminal side device such as a mobile phone, a tablet computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bracelet, a smart hand chain, a smart ring, a smart necklace, a smart anklet, and a smart chain), a smart wristband, smart clothes, and the like. It should be noted that a specific type of the terminal device 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), Centralized network configuration (CNC), a Network Repository Function (NRF), a Network Exposure Function (NEF), a local NEF (Local NEF or L-NEF), a Binding Support Function (BSF), an Application Function (AF), or the like. It should be noted that, in the embodiments of this application, only a core network device in an NR system is used as an example for description, and a specific type of the core network device is not limited.

To resolve the problem of poor transmission effects in terms of reliability, a delay, a throughput, and the like of a data transmission manner of single-path communication in a related technology, this application provides a data transmission manner of multi-path low-layer aggregation, so that a transmit end (a UE, a base station, or the like) can perform multi-path joint data transmission with a peer end at a granularity of a low-layer data unit. This can greatly improve reliability, a delay, a throughput, and power consumption performance of data transmission, and therefore improve data transmission effects. The following describes in detail a data transmission method provided in the embodiments of this application through some embodiments and application scenarios thereof with reference to the accompanying drawings.

According to a first aspect, FIG. 2 is a flowchart of a data transmission method according to an embodiment of this application. The method may include the following steps:

Step S201: A first terminal receives or generates configuration information of multi-path low-layer aggregation transmission, where the multi-path low-layer aggregation transmission includes multi-path MAC layer aggregation transmission and/or multi-path PHY layer aggregation transmission.

The first terminal may be a remote UE (remote terminal), and the first terminal is connected to a receive end (network side device or UE) through at least one relay UE (relay terminal).

In an implementation, the first terminal receives the configuration information of multi-path low-layer aggregation transmission that is sent by the network side device; or the first terminal receives the configuration information of multi-path low-layer aggregation transmission that is sent by a second terminal or a third terminal.

In a UE-to-network relay (UE-to-network side device relay) scenario, the second terminal is a relay terminal between the first terminal and the network side device. In a UE-to-UE relay scenario, the second terminal is a relay terminal between the first terminal and the third terminal.

Step S202: The first terminal performs multi-path low-layer aggregation transmission based on the configuration information of multi-path low-layer aggregation transmission.

Aggregation transmission means that a transmit end sends data on a plurality of paths, and a receive end aggregates the data sent by the transmit end on the plurality of paths. During specific implementation, when the first terminal is configured to perform multi-path transmission in a low-layer aggregation manner of MAC aggregation (Media Access Control aggregation) or PHY aggregation (Physical aggregation), on each path of the first terminal, data of the first terminal is correspondingly sent in a joint manner such as splitting or duplication at a granularity of a low-layer data unit of a MAC PDU (MAC protocol data unit) or a PHY TB (physical layer transport block), and the receive end processes (for example, combines or separately receives) the low-layer data unit sent on each path, to improve receiving reliability and delay performance of data transmission in a data transmission manner of multi-path low-layer aggregation, which is conducive to improving a throughput and can meet extremely high QoS requirements of various services.

It can be learned from the foregoing steps that the first terminal performs multi-path MAC layer aggregation transmission and/or multi-path PHY layer aggregation transmission based on the configuration information of multi-path low-layer aggregation transmission that is received or generated by the first terminal, to perform multi-path joint data transmission with a peer end at a granularity of a low-layer data unit, so that data transmission effects in terms of reliability, a delay, a throughput, and the like of data transmission can be improved.

### Implementation 1

This implementation describes a case of configuring multi-path low-layer aggregation transmission, and the UE-to-network relay scenario is used as an example for description.

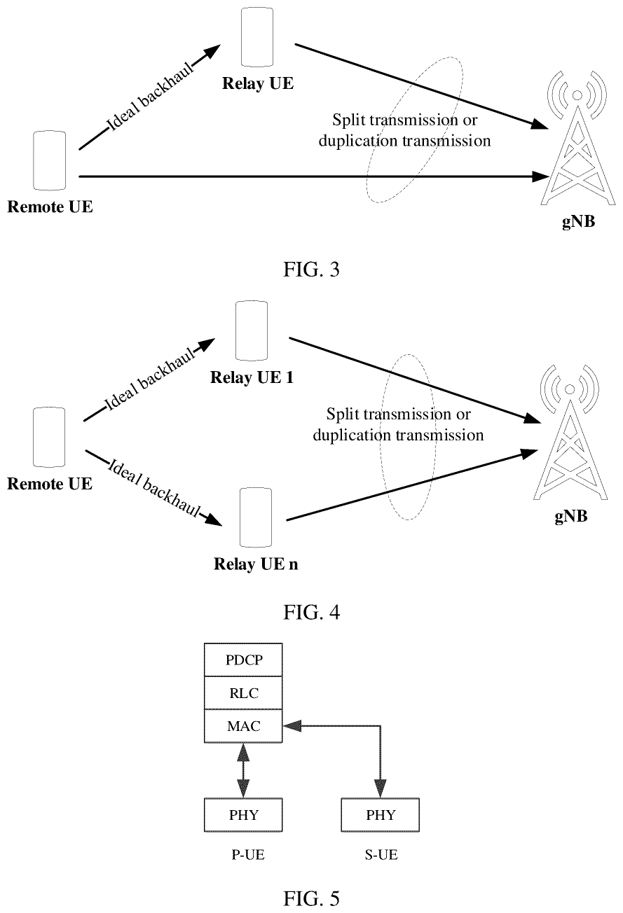

A remote UE (first terminal) and a gNB (network side device) communicate through a plurality of paths. For example, the plurality of paths may include a direct path and/or an indirect path relayed through a relay UE (second terminal), and there may be a plurality of indirect paths. Interfaces between the remote UE and the relay UE are all ideal backhaul connections. Refer to a data transmission scenario shown in FIG. 3 or FIG. 4, and a schematic diagram of a protocol stack architecture shown in FIG. 5. A primary-UE (P-UE, primary UE) shown in FIG. 5 is equivalent to a remote UE in FIG. 3 or FIG. 4, and a secondary-UE (S-UE, secondary UE) is equivalent to a relay UE. As shown in FIG. 5, data of the remote UE is aggregated at a MAC layer through two or more paths, to implement multi-path split or duplication transmission at a granularity of a MAC PDU.

It may be understood that in the UE-to-network relay multi-path scenario, to support multi-path configuration, all nodes, including the remote UE and each relay UE, need to be in an RRC CONNECTED (Radio Resource Control CONNECTED, radio resource control connected) state, in other words, each UE and a serving gNB (serving base station) can interact with each other using RRC dedicated signaling, so that all interaction processes between the network side device and a terminal (first terminal, second terminal, or third terminal) described below can be implemented using RRC dedicated signaling.

In this embodiment, the gNB (network side device) needs to first obtain a related capability and a link condition of multi-path low-layer aggregation transmission of each UE, and then perform configuration and a related scheduling operation on a UE that meets a capability requirement and a link requirement of multi-path low-layer aggregation transmission. Specifically, the gNB needs to know capability information of the remote UE and the relay UE, that is, whether the remote UE and each relay UE support MAC aggregation or PHY aggregation. In addition, the network side device may also know whether each UE has capabilities such as splitting, duplication on a same resource, and duplication on different resources. The capability information may be jointly reported in a reporting process of a UE capability, or may be reported in a set separate reporting process, for example, separately reported using UE assistance information, UE relay information, or other uplink signaling.

In addition, the UE also needs to report a backhaul condition between the remote UE and the relay UE, because only an ideal backhaul can meet a transmission requirement of MAC or PHY aggregation. The remote UE may uniformly report a backhaul condition between the remote UE and each relay UE, or each relay UE may report a backhaul condition between the relay UE and the remote UE. The backhaul condition may be reported using backhaul information, and the backhaul information may include: whether a specific backhaul is an ideal backhaul, whether the remote UE or each relay UE has an associated backhaul or an ideal backhaul, whether the remote UE or each relay UE or a UE associated with the remote UE or each relay UE supports MAC or PHY aggregation transmission, and the like.

Specifically, the backhaul information includes at least one of the following:
an identifier of the second terminal;
an identifier of a serving cell of the second terminal; or
whether a backhaul between the first terminal and the second terminal is an ideal backhaul.

In this embodiment, when the first terminal reports backhaul information, an identifier (for example, an ID) of a peer end (that is, the second terminal) needs to be carried. For example, the remote UE may report an ID of the relay UE, where the ID may be an S-TMSI (SAE Temporary Mobile Subscriber Identity), a C-RNTI (Cell Radio Network Temporary Identifier), an RNTI (Radio Network Temporary Identifier), or the like; or may report a serving cell ID of the relay UE, so that the gNB knows whether the relay UE is in a cell in which the gNB can perform scheduling. It may be understood that when the second terminal reports backhaul information, the second terminal may also report an ID of the remote UE or a serving cell ID of the remote UE. UE assistance information, UE relay information, or other uplink signaling may be used in the reporting process.

In an implementation, the first terminal sends first indication information and/or the backhaul information, where the first indication information is used to indicate whether the first terminal supports multi-path low-layer aggregation transmission, and the backhaul information is used to indicate a backhaul condition between the first terminal and the second terminal.

It may be understood that backhaul condition reporting and capability reporting may be performed independently or jointly. A joint reporting manner is that when a UE reports a backhaul condition indicating an ideal backhaul, it is considered by default that the UE supports a MAC or PHY aggregation transmission capability; or when a UE reports that the UE supports a MAC or PHY aggregation transmission capability, and an ID of an associated UE is carried, it is considered by default that there is an ideal backhaul between the UE and the associated UE.

Reporting of the UE (first terminal or second terminal) may be divided into the following three manners:

Reporting manner 1 (default reporting): In this implementation, regardless of whether the network side device supports multi-path low-layer aggregation, the UE reports capability information indicating whether the UE supports multi-path low-layer aggregation transmission. For example, in a process of reporting a UE capability, the UE automatically includes a description of whether the UE supports multi-path low-layer aggregation in existing capability reporting information. In a case that the network side device does not support multi-path low-layer aggregation, the network side device may ignore the description included in the capability reporting information.

Reporting manner 2 (network side switch-based reporting): In this implementation, the network side device sends a reporting permission notification to a terminal, where the reporting permission notification indicates that the network side device permits the terminal to report first indication information and/or backhaul information. For example, when the network side device supports multi-path low-layer aggregation, the network side device may use an SIB (System Information Block) or dedicated signaling to send a reporting permission notification to the UE. After receiving the reporting permission notification, the UE reports first indication information and/or backhaul information.

Reporting manner 3 (network side triggered or request-based reporting): In this implementation, the network side device sends a reporting request to a terminal, where the reporting request is used to request the terminal to report first indication information and/or backhaul information. For example, when the network side device supports multi-path low-layer aggregation and is to configure MAC or PHY aggregation transmission for the UE, the network side device sends a reporting request to obtain a capability condition and/or a backhaul condition of multi-path low-layer aggregation of the UE. After receiving the request, the UE reports related information.

After knowing a related capability and a link condition of multi-path low-layer aggregation transmission of each UE, the network side device selects an appropriate UE to participate in MAC or PHY aggregation transmission from a UE that supports a MAC or PHY aggregation transmission capability and an associated ideal backhaul (for example, in a case that the network side device has sufficient resources, the network side device may select all UEs that meet the capability requirement and the backhaul requirement to participate in multi-path low-layer aggregation transmission), and use a corresponding RRC dedicated signaling process for the selected UE to configure a parameter of MAC or PHY aggregation transmission.

Capabilities and backhaul conditions of all UEs may be reported to the network side device for uniform configuration, or transmitted to a header UE through interfaces between UEs for uniform configuration. The header UE may be the remote UE or a relay UE. When an ideal backhaul condition exists between UEs, the remote UE and the relay UE transmit same data or different content to a peer UE in an agreed manner, that is, through MAC or PHY aggregation. For example, the remote UE and a relay UE 1 use a same source layer 2 ID or different source layer 2 IDs and a same PC5 interface resource or different PC5 interface resources to transmit duplication and split data to a peer remote UE. In other words, the remote UE, the relay UE, and a receive end remote UE need to agree or configure in advance which data requires duplication sending, combining reception, and single-copy delivery to a higher layer after duplication detection, and which data requires split sending, separate reception, and full delivery to the higher layer.

The configuration information of multi-path low-layer aggregation transmission includes at least one of the following:
a logical architecture related to multi-path MAC layer aggregation transmission;
a logical architecture related to multi-path PHY layer aggregation transmission;
information used to indicate to perform split transmission;
information used to indicate to perform duplication transmission, information used to indicate to perform duplication transmission using a same resource, or information used to indicate to perform duplication transmission using different resources;
a data type applicable to multi-path MAC layer aggregation transmission and/or multi-path PHY layer aggregation transmission;
a transmission direction applicable to multi-path low-layer aggregation transmission; or
information related to the second terminal replacing the first terminal to send uplink data and/or an uplink feedback.

In this embodiment, the logical architecture related to multi-path MAC layer aggregation transmission refers to an association relationship between a MAC entity and two or more transmission links (for example, PHY layers (physical layers) of different UEs); the logical architecture related to multi-path PHY layer aggregation transmission refers to an association relationship between a PHY entity and two or more transmission links (for example, transmission antennas of different UEs); the data type applicable to multi-path MAC layer aggregation transmission and/or multi-path PHY layer aggregation transmission may be a specific DRB (Data Radio Bearer), QoS (Quality of Service), all user data of the remote UE, or another data type.

It may be understood that the configuration information of multi-path low-layer aggregation transmission may be configured only for uplink or downlink, or data transmission in one transmission direction between UEs. When a set of parameters (that is, the configuration information of multi-path low-layer aggregation transmission) is only for one direction, a set of parameters may be configured for each transmission direction. The configuration information of multi-path low-layer aggregation transmission may be applied to both uplink and downlink, or two transmission directions between UEs.

In addition, in a case that a UE needs to act as a proxy to transmit uplink data or an uplink PUCCH (Physical Uplink Control Channel)/HARQ feedback for another UE, different uplink and downlink transmission paths or dedicated PUCCH/HARQ feedback resource binding needs to be configured for the UE whose transmission is relayed, and the UE used for proxy transmission performs proxy transmission based on the corresponding path or resource configured for the UE whose transmission is relayed.

When there are a large quantity of UEs, the network side device may also configure different MAC or PHY aggregation transmission groups. For example, the remote UE and the relay UE 1 form a group 1 for MAC or PHY aggregation transmission, the remote UE and a relay UE 2 form a group 2 for MAC or PHY aggregation transmission, and the remote UE, the relay UE 1, and a relay UE 3 form a group 3 for MAC or PHY aggregation transmission. In the UE-to-UE scenario, the foregoing configuration manner can also be used to obtain configurations of different MAC or PHY aggregation transmission groups.

After receiving the configuration information of multi-path low-layer aggregation transmission, each UE or transmission group immediately applies a related configuration, and performs MAC or PHY aggregation reception and transmission according to an agreement.

In an implementation, the terminal (first terminal, second terminal, or third terminal) receives or generates configuration update information of multi-path low-layer aggregation transmission, and the terminal stops multi-path low-layer aggregation transmission based on the configuration update information of multi-path low-layer aggregation transmission.

During multi-path low-layer aggregation transmission, when the base station decides to exit MAC or PHY aggregation transmission based on an algorithm or another input factor (for example, insufficient resources or a low processing capability of the base station), the base station needs to perform configuration update to a UE that has obtained a configuration, release a previous MAC or PHY aggregation transmission configuration, and end MAC or PHY aggregation transmission.

In an implementation, the terminal sends multi-path low-layer aggregation transmission capacity limitation information to the network side device, where the multi-path low-layer aggregation transmission capacity limitation information is used to indicate that the multi-path low-layer aggregation transmission capacity of the terminal is limited; and/or the first terminal sends changed backhaul information.

In this embodiment, when a condition of the remote UE or the relay UE changes, for example, a processing capacity is limited, or a backhaul is no longer an ideal backhaul, the UE may also actively report and update information to the network side device, to be specific, report, to the network side device, information indicating that the UE no longer supports MAC or PHY aggregation transmission, so that the network side device can remove the UE from a MAC or PHY aggregation transmission range, or end MAC or PHY aggregation transmission.

### Implementation 2

This implementation describes a case of performing multi-path low-layer aggregation transmission operations, and the UE-to-network relay scenario is used as an example. After configuration of MAC or PHY aggregation transmission has been completed, a related UE needs to monitor a C-RNTI and complete transmission.

In this embodiment, a terminal (first terminal, second terminal, or third terminal) performs at least one of the following operations:
the terminal monitors scheduling of a C-RNTI;
the terminal generates a MAC layer PDU and/or a PHY layer TB based on a size of a scheduling resource;
the terminal performs duplication transmission of the MAC layer PDU and/or the PHY layer TB on a same resource or different resources through different paths based on the configuration information or control signaling of multi-path low-layer aggregation transmission, where
the control signaling is used to indicate a data transmission manner of each UE through dynamic control, and a specific implementation of dynamic control is to be described in an implementation 3;
the terminal performs split transmission of the MAC layer PDU and/or the PHY layer TB on different resources through different paths based on the configuration information or the control signaling; or
the terminal sends, to the second terminal based on the configuration information, uplink data and/or an uplink feedback that need/needs to be sent to the network side device.

The following describes different cases:

Case 1: MAC/PHY split transmission. During specific implementation, in the case of MAC/PHY split transmission, different scheduling is applied to each path or each participating UE, that is, each remote UE or relay UE monitors scheduling of a C-RNTI of the remote UE or relay UE, the remote UE generates different MAC PDUs or PHY TBs based on sizes of scheduling resources, and the MAC PDUs or PHY TBs are transmitted on actual wireless links of the remote UE and relay UE. These MAC PDUs or PHY TBs are separately received at the receive end, and successfully received data is delivered to a higher layer for further processing. This manner is equivalent to increasing a processing capability and a bandwidth of transmission, greatly improving an uplink data rate of the remote UE. Similar processing is performed for downlink. A base station may schedule different downlink channels of the remote UE and relay UE, to meet a requirement of high-speed downlink transmission.

Case 2: MAC/PHY duplication transmission. During specific implementation, in the case of MAC/PHY duplication transmission, scheduling is applied to each path or each participating UE, that is, each remote UE or relay UE monitors scheduling of a C-RNTI of the remote UE or relay UE. The remote UE monitors scheduling of a C-RNTI of the remote UE, generates a MAC layer PDU and/or a PHY layer TB based on a size of a scheduling resource, duplicates the MAC layer PDU and/or the PHY layer TB, and sends the duplicated MAC layer PDU and/or PHY layer TB to the relay UE, to implement MAC/PHY duplication transmission. The receive end performs combining reception, and delivers one copy of successfully received data to a higher layer for further processing. The remaining duplicated data can be deleted. This manner is equivalent to increasing reliability and a delay characteristic of transmission. Similar processing is performed for downlink. A base station may schedule different downlink channels of the remote UE and relay UE for duplication transmission, to meet a transmission requirement of downlink URLLC.

Usually, to perform duplication transmission, sizes of data that can be transmitted on scheduling resources need to be the same. The base station may schedule a same resource or different resources for a plurality of UEs for duplication data transmission.

In a case of a same resource, an advantage is that duplication transmission effects are achieved by consuming one resource, to achieve URLLC effects of duplication without increasing resource consumption, but there is a high requirement on synchronous sending between UEs. In a case of different resources, different UEs send same duplication data on different resources, which is equivalent to trading higher resource consumption for URLLC (Ultra-Reliable Low-Latency Communication) effects of duplication. In this case, each UE may be considered to separately send same data, and there is no additional requirement for synchronous sending between UEs, which is similar to simultaneous sending of uplink data by two UEs in an existing system.

In the case of a same resource, it is best to use a same HARQ process ID and an HARQ process for processing between different UEs, to facilitate HARQ synchronous reception at the receive end. In the case of different resources, a same HARQ process ID and HARQ process or different HARQ process IDs and HARQ processes may be used for processing between different UEs. In a case of using a same resource, HARQ process ID, and HARQ process, the receive end may perform HARQ buffer soft combining. For example, the receive end receives 100 bytes transmitted by a specific UE, and the first 50 bytes are decoded correctly. Then, the 100 bytes are transmitted again in HARQ retransmission of the UE or by another UE that uses the same HARQ process. In this case, the receive end decodes the last 50 bytes of the 100 bytes correctly. Then, the receive end may combine the first 50 bytes and the last 50 bytes that are correctly transmitted in the two times of transmission, to implement correct transmission of the 100 bytes.

It may be understood that from a UL (uplink) perspective, in the case of a same resource, when the gNB does not perform reception successfully, retransmission is scheduled on another same resource, and the UE performs retransmission; or in the case of different resources, when the gNB does not perform reception successfully, retransmission is scheduled on another different resource, and the UE performs retransmission. In both cases, in a case that the gNB performs reception successfully, scheduling new transmission can end previous transmission, and the gNB does not need to perform HARQ feedback. From a DL (downlink) perspective, in the case of a same resource, when the remote UE ultimately determines that reception is not successful or is successful, HARQ feedback is performed at a feedback location corresponding to the resource, and the gNB performs retransmission or considers that the process ends; or in the case of different resources, when the remote UE ultimately determines that reception is not successful or is successful, HARQ feedback is performed at one of feedback locations corresponding to the different resources or at feedback locations corresponding to a plurality of resources, and the gNB performs retransmission or considers that the process ends. Feedback locations of same resources are the same, and a single UE may feedback a common result (that is, in a case that one UE determines that reception is successful, it is considered that all UEs successfully perform reception; and in this case, a result indicating successful reception of the UEs is fed back, and retransmission is not required), or a plurality of UEs may feedback a common transmission result.

Case 3: Uplink and downlink separation transmission. The first terminal sends, to the second terminal based on the configuration information, uplink data and/or an uplink feedback that need/needs to be sent to the network side device. In this embodiment, in a case of MAC/PHY uplink separation or PUCCH/HARQ feedback proxy transmission, transmission is performed on a configured uplink separation path. For example, when the remote UE has any UL data or UL control PDU (uplink control protocol data unit) such as a PDCP control PDU or an RLC ARQ feedback, the UL data or the UL control PDU needs to be transmitted by another relay UE on a pre-configured path, and the remote UE avoids sending the uplink data, to deal with a case of an insufficient uplink capacity, limited uplink power consumption, or pursuing uplink energy saving.

Similarly, the remote UE may also need to avoid sending any uplink signal. For example, a PUCCH or HARQ feedback of the remote UE needs to be configured to one or more other relay UEs, and these relay UEs perform proxy transmission for the remote UE. In this case, the remote UE delivers, to the relay UE, PUCCH or HARQ feedback information that the remote UE needs to send, and the relay UE sends the information for the remote UE.

### Implementation 3

This implementation describes a specific implementation case of dynamic control. Based on descriptions of the implementation 1 and the implementation 2, it can be learned that MAC aggregation transmission, PHY aggregation transmission, or the like has two most basic transmission manners, that is, split transmission and duplication transmission. An essential difference between these two transmission manners is whether data content sent on different paths is the same or different. A UE needs to use a corresponding data transmission manner based on a difference between the data content sent on the different paths. Therefore, control signaling may be used to notify the UE of the current difference between the data content sent on the different paths, to dynamically control the data transmission manner of the UE.

The following three types of control signaling may be used to dynamically control the data transmission manner of the UE:

A first type is RRC signaling, where content of the RRC signaling is RRC configuration information or RRC reconfiguration information. In this embodiment, the RRC configuration information is used to set which low-layer aggregation transmission manner in MAC aggregation transmission and PHY aggregation transmission is currently being executed, and whether the split mode or the duplication mode is used. The UE and the network side device subsequently perform corresponding data transmission operations based on the RRC configuration information. In a case that a current data transmission operation needs to be changed, the data transmission manner is reconfigured based on the RRC reconfiguration information. For example, the split mode or the duplication mode of current data transmission is reconfigured.

A second type is L1 signaling or L2 signaling used to indicate to perform switching between the split transmission mode and the duplication transmission mode. In this embodiment, switching or changing between the split mode and the duplication mode may be semi-dynamically performed by using the L2/L1 signaling such as a MAC CE (MAC Control Element) or PDCCH DCI (PDCCH Downlink Control Information). After receiving the L2/L1 signaling, the UE performs a data transmission operation corresponding to the signaling according to the indication. In a case that a current data transmission operation needs to be changed, the UE needs to be notified again by using L2/L1 signaling. After receiving the signaling, the UE performs a corresponding data transmission operation.

A third type is L1 signaling used to indicate a mode of each time of multi-path low-layer aggregation transmission. In this embodiment, a data transmission manner is dynamically indicated by using the L1 signaling. For example, when a new UL grant (physical control information) is scheduled on a PDCCH, whether a current data transmission operation is based on the split mode or the duplication mode is directly indicated, or the split mode is set by default and the duplication mode is explicitly indicated, to help the remote UE perform a related data transmission operation. The indication can be provided only to the remote UE, or to both the remote UE and a participating relay UE. At each time of new scheduling (that is, a new time of multi-path low-layer aggregation transmission), whether the current data transmission is performed in the split mode or the duplication mode is independently determined based on the control signaling. Each time of data transmission of the remote UE is performed according to an indication of corresponding control signaling. For example, different data or same data is sent on different paths according to the indication of the control signaling.

It may be understood that, for data retransmission, data in a HARQ buffer is retransmitted, so that it may be not considered as a new time of data transmission. Therefore, a transmission manner of data retransmission can follow an original data transmission manner, or control signaling can be used for mode switching. This is not limited in this application. In addition, for a case of MAC/PHY uplink separation, PUCCH/HARQ feedback proxy transmission, or the like, the foregoing three types of control signaling may also be used to perform similar mode switching or dynamic control of a data transmission manner.

According to a second aspect, FIG. 6 shows another data transmission method according to an embodiment of this application. The method includes at least the following steps:

Step S301: A second terminal receives or generates configuration information of multi-path low-layer aggregation transmission, where the multi-path low-layer aggregation transmission includes multi-path MAC layer aggregation transmission and/or multi-path PHY layer aggregation transmission.

Step S302: The second terminal performs multi-path low-layer aggregation transmission based on the configuration information of multi-path low-layer aggregation transmission.

The second terminal is a relay terminal between a first terminal and a network side device, or the second terminal is a relay terminal between the first terminal and a third terminal.

In an implementation, that the second terminal receives configuration information of multi-path low-layer aggregation transmission includes:
the second terminal receives the configuration information of multi-path low-layer aggregation transmission that is sent by the network side device; or
the second terminal receives the configuration information of multi-path low-layer aggregation transmission that is sent by the first terminal or the third terminal.

In an implementation, the method further includes at least one of the following:
the second terminal sends first indication information, where the first indication information is used to indicate whether the second terminal supports multi-path low-layer aggregation transmission; or
the second terminal sends backhaul information, where the backhaul information is used to indicate a backhaul condition between the second terminal and the first terminal.

In an implementation, the backhaul information includes at least one of the following:
an identifier of the first terminal;
an identifier of a serving cell of the first terminal; or
whether a backhaul between the second terminal and the first terminal is an ideal backhaul.

In an implementation, the method further includes at least one of the following:
the second terminal receives a reporting permission notification sent by the network side device, where the reporting permission notification indicates that the network side device permits the second terminal to report the first indication information and/or the backhaul information; or
the second terminal receives a reporting request sent by the network side device, where the reporting request is used to request the second terminal to report the first indication information and/or the backhaul information.

In an implementation, the configuration information of multi-path low-layer aggregation transmission includes at least one of the following:
a logical architecture related to multi-path MAC layer aggregation transmission;
a logical architecture related to multi-path PHY layer aggregation transmission;
information used to indicate to perform split transmission;
information used to indicate to perform duplication transmission, information used to indicate to perform duplication transmission using a same resource, or information used to indicate to perform duplication transmission using different resources;
a data type applicable to multi-path MAC layer aggregation transmission and/or multi-path PHY layer aggregation transmission;
a transmission direction applicable to multi-path low-layer aggregation transmission; or
information related to the second terminal replacing the first terminal to send uplink data and/or an uplink feedback.

In an implementation, the method further includes at least one of the following:
the second terminal sends second indication information to the network side device, where the second indication information is used to indicate that a multi-path low-layer aggregation transmission capability of the second terminal is limited; or
the second terminal sends changed backhaul information.

In an implementation, the method further includes:
the second terminal receives or generates configuration update information of multi-path low-layer aggregation transmission; and
the second terminal stops multi-path low-layer aggregation transmission based on the configuration update information of multi-path low-layer aggregation transmission.

In an implementation, the method further includes:
the second terminal determines, based on at least one of the following control signaling, whether a mode of multi-path low-layer aggregation transmission is a split transmission mode or a duplication transmission mode:
RRC signaling, where content of the RRC signaling is RRC configuration information or RRC reconfiguration information;
L1 signaling or L2 signaling used to indicate to perform switching between the split transmission mode and the duplication transmission mode; or
L1 signaling used to indicate a mode of each time of multi-path low-layer aggregation transmission.

In an implementation, that the second terminal performs multi-path low-layer aggregation transmission based on the configuration information includes at least one of the following:
the second terminal monitors scheduling of a C-RNTI;
the second terminal receives, based on a size of a scheduling resource, a MAC layer PDU and/or a PHY layer TB sent by the first terminal;
the second terminal performs duplication transmission of the MAC layer PDU and/or the PHY layer TB on a same resource or different resources through different paths based on the configuration information or the control signaling;
the second terminal performs split transmission of the MAC layer PDU and/or the PHY layer TB on different resources through different paths based on the configuration information or the control signaling; or
the second terminal receives, based on the configuration information, uplink data and/or an uplink feedback that are/is sent by the first terminal and that need/needs to be sent to the network side device.

The data transmission method provided in this embodiment of this application may be performed by the relay UE described above. For details, refer to the foregoing descriptions.

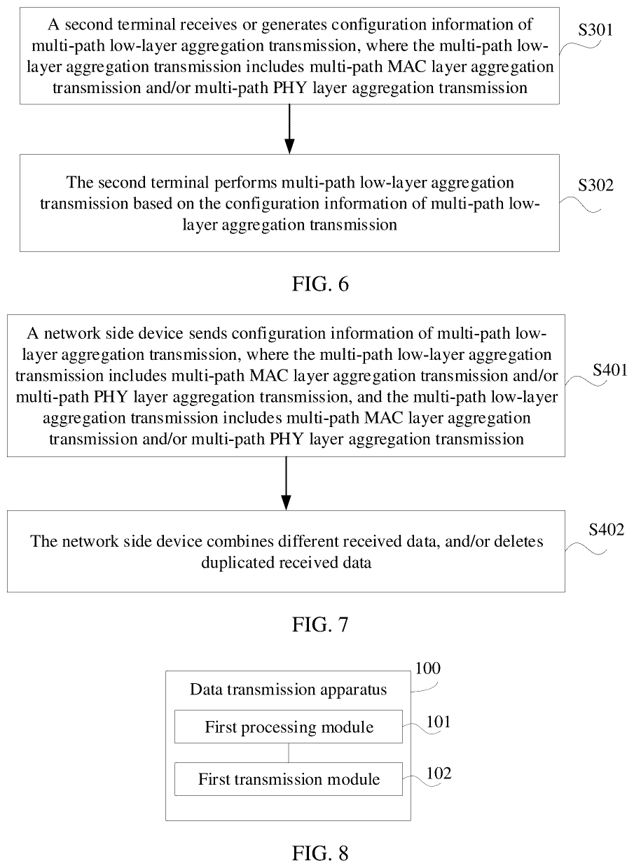

According to a third aspect, FIG. 7 shows another data transmission method according to an embodiment of this application. The method includes at least the following steps:

Step S401: A network side device sends configuration information of multi-path low-layer aggregation transmission, where the multi-path low-layer aggregation transmission includes multi-path MAC layer aggregation transmission and/or multi-path PHY layer aggregation transmission.

Step S402: The network side device combines different received data, and/or deletes duplicated received data.

In an implementation, the method further includes:
the network side device receives first indication information sent by a terminal, where the first indication information is used to indicate whether the terminal supports multi-path low-layer aggregation transmission; and
the network side device receives backhaul information sent by the terminal, where the backhaul information is used to indicate a backhaul condition between terminals.

In an implementation, the backhaul information includes at least one of the following:
an identifier of the terminal;
an identifier of a serving cell of the terminal; or
whether a backhaul between the terminals is an ideal backhaul.

In an implementation, the method further includes:
the network side device sends a reporting permission notification to the terminal, where the reporting permission notification indicates that the network side device permits the terminal to report the first indication information and/or the backhaul information; and
the network side device sends a reporting request to the terminal, where the reporting request is used to request the terminal to report the first indication information and/or the backhaul information.

In an implementation, the configuration information of multi-path low-layer aggregation transmission includes at least one of the following:
a logical architecture related to multi-path MAC layer aggregation transmission;
a logical architecture related to multi-path PHY layer aggregation transmission;
information used to indicate to perform split transmission;
information used to indicate to perform duplication transmission, information used to indicate to perform duplication transmission using a same resource, or information used to indicate to perform duplication transmission using different resources;
a data type applicable to multi-path MAC layer aggregation transmission and/or multi-path PHY layer aggregation transmission;
a transmission direction applicable to multi-path low-layer aggregation transmission; or
information related to a second terminal replacing a first terminal to send uplink data and/or an uplink feedback.

In an implementation, the method further includes:
the network side device receives second indication information and/or changed backhaul information sent by the terminal, where the second indication information is used to indicate that a multi-path low-layer aggregation transmission capability of the terminal is limited; and
the network side device sends configuration update information of multi-path low-layer aggregation transmission to the terminal, where the configuration update information of multi-path low-layer aggregation transmission is used to indicate the terminal to stop multi-path low-layer aggregation transmission.

In an implementation, the method further includes:
the network side device sends at least one of the following control signaling to the terminal, where the control instruction is used to indicate whether a mode of multi-path low-layer aggregation transmission is a split transmission mode or a duplication transmission mode:
RRC signaling, where content of the RRC signaling is RRC configuration information or RRC reconfiguration information;
L1 signaling or L2 signaling used to indicate to perform switching between the split transmission mode and the duplication transmission mode; or
L1 signaling used to indicate a mode of each time of multi-path low-layer aggregation transmission.

The data transmission method provided in this embodiment of this application may be performed by the network side device such as the base station in the UE-to-network relay scenario described above, or the third terminal in the UE-to-UE relay scenario. For details, refer to the foregoing descriptions.

According to a fourth aspect, an embodiment of this application provides a data transmission apparatus. The apparatus may be applied to a first terminal. As shown in FIG. 8, the data transmission apparatus 100 includes:
a first processing module 101, configured to receive or generate configuration information of multi-path low-layer aggregation transmission, where the multi-path low-layer aggregation transmission includes multi-path MAC layer aggregation transmission and/or multi-path PHY layer aggregation transmission; and
a first transmission module 102, configured to perform multi-path low-layer aggregation transmission based on the configuration information of multi-path low-layer aggregation transmission.

In some embodiments, the first processing module 101 includes:
a first processing submodule, configured to receive the configuration information of multi-path low-layer aggregation transmission that is sent by the network side device; or configured to receive the configuration information of multi-path low-layer aggregation transmission that is sent by a second terminal or a third terminal.

In some embodiments, the apparatus further includes at least one of the following:
a first sending module, configured to send first indication information, where the first indication information is used to indicate whether the first terminal supports multi-path low-layer aggregation transmission; or
a second sending module, configured to send backhaul information, where the backhaul information is used to indicate a backhaul condition between the first terminal and the second terminal.

In some embodiments, the backhaul information includes at least one of following:
an identifier of the second terminal;
an identifier of a serving cell of the second terminal; or
whether a backhaul between the first terminal and the second terminal is an ideal backhaul.

In some embodiments, the apparatus further includes at least one of the following:
a first receiving module, configured to receive a reporting permission notification sent by the network side device, where the reporting permission notification indicates that the network side device permits the first terminal to report the first indication information and/or the backhaul information; or
a second receiving module, configured to receive a reporting request sent by the network side device, where the reporting request is used to request the first terminal to report the first indication information and/or the backhaul information.

In some embodiments, the configuration information of multi-path low-layer aggregation transmission includes at least one of the following:
a logical architecture related to multi-path MAC layer aggregation transmission;
a logical architecture related to multi-path PHY layer aggregation transmission;
information used to indicate to perform split transmission;
information used to indicate to perform duplication transmission, information used to indicate to perform duplication transmission using a same resource, or information used to indicate to perform duplication transmission using different resources;
a data type applicable to multi-path MAC layer aggregation transmission and/or multi-path PHY layer aggregation transmission;
a transmission direction applicable to multi-path low-layer aggregation transmission; or
information related to the second terminal replacing the first terminal to send uplink data and/or an uplink feedback.

In some embodiments, the apparatus further includes at least one of the following:
a third sending module, configured to send second indication information to a network side device, where the second indication information is used to indicate that a multi-path low-layer aggregation transmission capability of the first terminal is limited; or a fourth sending module, configured to send changed backhaul information.

In some embodiments, the apparatus further includes:
a third receiving module, configured to receive or generate configuration update information of multi-path low-layer aggregation transmission; and
a first terminal processing module, configured to stop multi-path low-layer aggregation transmission based on the configuration update information of multi-path low-layer aggregation transmission.

In some embodiments, the apparatus further includes:
a second terminal processing module, configured to determine, based on at least one of the following control signaling, whether a mode of multi-path low-layer aggregation transmission is a split transmission mode or a duplication transmission mode:
RRC signaling, where content of the RRC signaling is RRC configuration information or RRC reconfiguration information;
L1 signaling or L2 signaling used to indicate to perform switching between the split transmission mode and the duplication transmission mode; or
L1 signaling used to indicate a mode of each time of multi-path low-layer aggregation transmission.

In some embodiments, the first transmission module 102 includes at least one of the following:
a first transmission submodule, configured to monitor scheduling of a C-RNTI;
a second transmission submodule, configured to generate a MAC layer PDU and/or a PHY layer TB based on a size of a scheduling resource;
a third transmission submodule, configured to perform duplication transmission of the MAC layer PDU and/or the PHY layer TB on a same resource or different resources through different paths based on the configuration information or the control signaling;
a fourth transmission submodule, configured to perform split transmission of the MAC layer PDU and/or the PHY layer TB on different resources through different paths based on the configuration information or the control signaling; or
a fifth transmission submodule, configured to send, to the second terminal based on the configuration information, uplink data and/or an uplink feedback that need/needs to be sent to the network side device.

The data transmission apparatus provided in this embodiment of this application can implement processes implemented in the embodiment of the data transmission method according to the first aspect, and same technical effects are achieved. To avoid repetition, details are not described herein again.

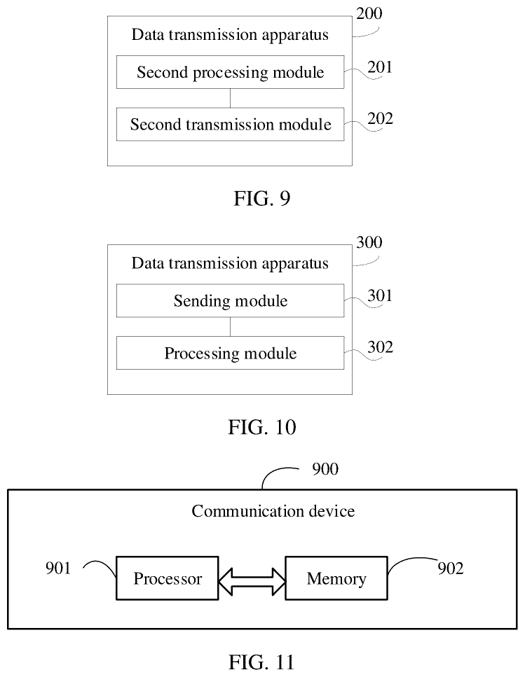

According to a fifth aspect, an embodiment of this application provides another data transmission apparatus. The apparatus may be applied to a second terminal, where the second terminal is a relay terminal between a first terminal and a network side device, or the second terminal is a relay terminal between the first terminal and a third terminal. As shown in FIG. 9, the data transmission apparatus 200 includes:
a second processing module 201, configured to receive or generate configuration information of multi-path low-layer aggregation transmission, where the multi-path low-layer aggregation transmission includes multi-path MAC layer aggregation transmission and/or multi-path PHY layer aggregation transmission; and
a second transmission module 202, configured to perform multi-path low-layer aggregation transmission based on the configuration information of multi-path low-layer aggregation transmission.

In some embodiments, the second processing module 201 includes:
a second processing submodule, configured to receive the configuration information of multi-path low-layer aggregation transmission that is sent by the network side device; or configured to receive the configuration information of multi-path low-layer aggregation transmission that is sent by the first terminal or the third terminal.

In some embodiments, the apparatus further includes at least one of the following:
a fifth sending module, configured to send first indication information, where the first indication information is used to indicate whether the second terminal supports multi-path low-layer aggregation transmission; and
a sixth sending module, configured to send backhaul information, where the backhaul information is used to indicate a backhaul condition between the second terminal and the first terminal.

In some embodiments, the backhaul information includes at least one of following:
an identifier of the first terminal;
an identifier of a serving cell of the first terminal; and
whether a backhaul between the second terminal and the first terminal is an ideal backhaul.

In some embodiments, the apparatus further includes at least one of the following:
a fourth receiving module, configured to receive a reporting permission notification sent by the network side device, where the reporting permission notification indicates that the network side device permits the second terminal to report the first indication information and/or the backhaul information; and
a fifth receiving module, configured to receive a reporting request sent by the network side device, where the reporting request is used to request the second terminal to report the first indication information and/or the backhaul information.

In some embodiments, the configuration information of multi-path low-layer aggregation transmission includes at least one of the following:
a logical architecture related to multi-path MAC layer aggregation transmission;
a logical architecture related to multi-path PHY layer aggregation transmission;
information used to indicate to perform split transmission;
information used to indicate to perform duplication transmission, information used to indicate to perform duplication transmission using a same resource, or information used to indicate to perform duplication transmission using different resources;
a data type applicable to multi-path MAC layer aggregation transmission and/or multi-path PHY layer aggregation transmission;
a transmission direction applicable to multi-path low-layer aggregation transmission; and
information related to the second terminal replacing the first terminal to send uplink data and/or an uplink feedback.

In some embodiments, the apparatus further includes at least one of the following:
a seventh sending module, configured to send second indication information to a network side device, where the second indication information is used to indicate that a multi-path low-layer aggregation transmission capability of the second terminal is limited; and
an eighth sending module, configured to send changed backhaul information.

In some embodiments, the apparatus further includes:
a sixth receiving module, configured to receive or generate configuration update information of multi-path low-layer aggregation transmission; and
a third terminal processing module, configured to stop multi-path low-layer aggregation transmission based on the configuration update information of multi-path low-layer aggregation transmission.

In some embodiments, the apparatus further includes:
a fourth terminal processing module, configured to determine, based on at least one of the following control signaling, whether a mode of multi-path low-layer aggregation transmission is a split transmission mode or a duplication transmission mode:
RRC signaling, where content of the RRC signaling is RRC configuration information or RRC reconfiguration information;
L1 signaling or L2 signaling used to indicate to perform switching between the split transmission mode and the duplication transmission mode; and
L1 signaling used to indicate a mode of each time of multi-path low-layer aggregation transmission.

In some embodiments, the second transmission module 202 includes at least one of the following:
a sixth transmission submodule, configured to monitor scheduling of a C-RNTI;
a seventh transmission submodule, configured to receive, based on a size of a scheduling resource, a MAC layer PDU and/or a PHY layer TB sent by the first terminal;
an eighth transmission submodule, configured to perform duplication transmission of the MAC layer PDU and/or the PHY layer TB on a same resource or different resources through different paths based on the configuration information or the control signaling;
a ninth transmission submodule, configured to perform split transmission of the MAC layer PDU and/or the PHY layer TB on different resources through different paths based on the configuration information or the control signaling; and
a tenth transmission submodule, configured to receive, based on the configuration information, uplink data and/or an uplink feedback that are/is sent by the first terminal and that need/needs to be sent to the network side device.

The data transmission apparatus provided in this embodiment of this application can implement processes implemented in the embodiment of the data transmission method according to the second aspect, and same technical effects are achieved. To avoid repetition, details are not described herein again.

According to a sixth aspect, an embodiment of this application provides another data transmission apparatus. The apparatus may be applied to a network side device. As shown in FIG. 10, the data transmission apparatus 300 includes:
a sending module 301, configured to send configuration information of multi-path low-layer aggregation transmission, where the multi-path low-layer aggregation transmission includes multi-path MAC layer aggregation transmission and/or multi-path PHY layer aggregation transmission; and
a processing module 302, configured to: combine different received data, and/or delete duplicated received data.

In some embodiments, the apparatus further includes:
a first network receiving module, configured to receive first indication information sent by a terminal, where the first indication information is used to indicate whether the terminal supports multi-path low-layer aggregation transmission; and
a second network receiving module, configured to receive backhaul information sent by the terminal, where the backhaul information is used to indicate a backhaul condition between terminals.

In some embodiments, the backhaul information includes at least one of following:
an identifier of the terminal;
an identifier of a serving cell of the terminal; and
whether a backhaul between the terminals is an ideal backhaul.

In some embodiments, the apparatus further includes:
a first network sending module, configured to send a reporting permission notification to the terminal, where the reporting permission notification indicates that the network side device permits the terminal to report the first indication information and/or the backhaul information; and
a second network sending module, configured to send a reporting request to the terminal, where the reporting request is used to request the terminal to report the first indication information and/or the backhaul information.

In some embodiments, the configuration information of multi-path low-layer aggregation transmission includes at least one of the following:
a logical architecture related to multi-path MAC layer aggregation transmission;
a logical architecture related to multi-path PHY layer aggregation transmission;
information used to indicate to perform split transmission;
information used to indicate to perform duplication transmission, information used to indicate to perform duplication transmission using a same resource, or information used to indicate to perform duplication transmission using different resources;
a data type applicable to multi-path MAC layer aggregation transmission and/or multi-path PHY layer aggregation transmission;
a transmission direction applicable to multi-path low-layer aggregation transmission; and
information related to a second terminal replacing a first terminal to send uplink data and/or an uplink feedback.

In some embodiments, the apparatus further includes:
a third network receiving module, configured to receive second indication information and/or changed backhaul information sent by the terminal, where the second indication information is used to indicate that a multi-path low-layer aggregation transmission capability of the terminal is limited; and
a third network sending module, configured to send configuration update information of multi-path low-layer aggregation transmission to the terminal, where the configuration update information of multi-path low-layer aggregation transmission is used to indicate the terminal to stop multi-path low-layer aggregation transmission.

In some embodiments, the apparatus further includes:
a fourth network sending module, configured to send at least one of the following control signaling to the terminal, where the control instruction is used to indicate whether a mode of multi-path low-layer aggregation transmission is a split transmission mode or a duplication transmission mode:
RRC signaling, where content of the RRC signaling is RRC configuration information or RRC reconfiguration information;
L1 signaling or L2 signaling used to indicate to perform switching between the split transmission mode and the duplication transmission mode; and
L1 signaling used to indicate a mode of each time of multi-path low-layer aggregation transmission.

The data transmission apparatus provided in this embodiment of this application can implement processes implemented in the embodiment of the data transmission method according to the third aspect, and same technical effects are achieved. To avoid repetition, details are not described herein again.

As shown in FIG. 11, an embodiment of this application further provides a communication device 900. The device includes a processor 901 and a memory 902. The memory 902 stores a program or instructions that can be run on the processor 901. For example, when the communication device 900 is a terminal, and the program or the instructions are executed by the processor 901, the steps in the embodiment of the data transmission method according to the first aspect or the second aspect are implemented, and same technical effects can be achieved. When the communication device 900 is a network side device, and the program or the instructions are executed by the processor 901, the steps in the embodiment of the data transmission method according to the third aspect are implemented, and same technical effects can be achieved. To avoid repetition, details are not described herein again.

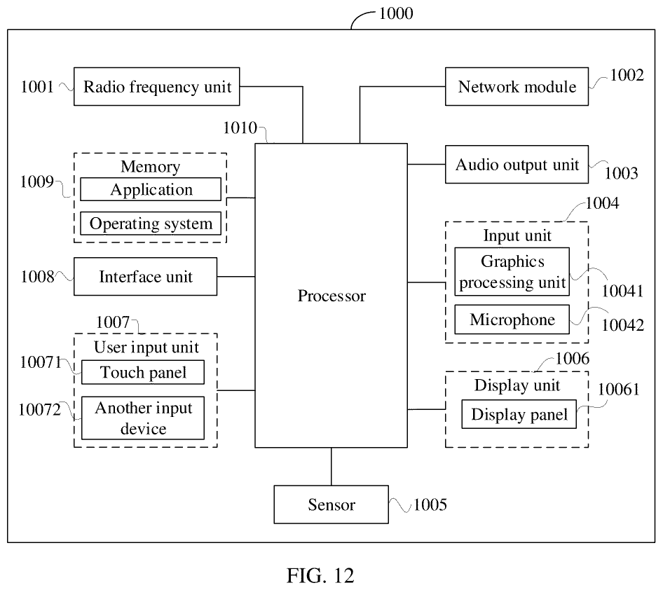

FIG. 12 is a schematic diagram of a hardware structure of a terminal according to an embodiment of this application.

The terminal 1000 is configured to perform the steps in the embodiment of the data transmission method according to the first aspect or the second aspect, and same technical effects can be achieved. The terminal 1000 includes but is not limited to at least a part of components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 12 constitutes no limitation on the terminal, and the terminal may include more or fewer components than those shown in the figure, or combine some components, or have different component arrangements. Details are not described herein.

It should be understood that in this embodiment of this application, the input unit 1004 may include a Graphics Processing Unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1001 may transmit the downlink data to the processor 1010 for processing. In addition, the radio frequency unit 1001 may send uplink data to the network side device. Generally, the radio frequency unit 1001 includes but is not limited to an antenna, an amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may be a volatile memory or a non-volatile memory, or the memory 1009 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1009 in this embodiment of this application includes but is not limited to these memories and any memory of another proper type.

The processor 1010 may include one or more processing units. In some embodiments, an application processor and a modem processor are integrated into the processor 1010. The application processor mainly processes an operating system, a user interface, an application, or the like. The modem processor mainly processes a wireless communication signal, for example, a baseband processor. It may be understood that the modem processor may not be integrated into the processor 1010.

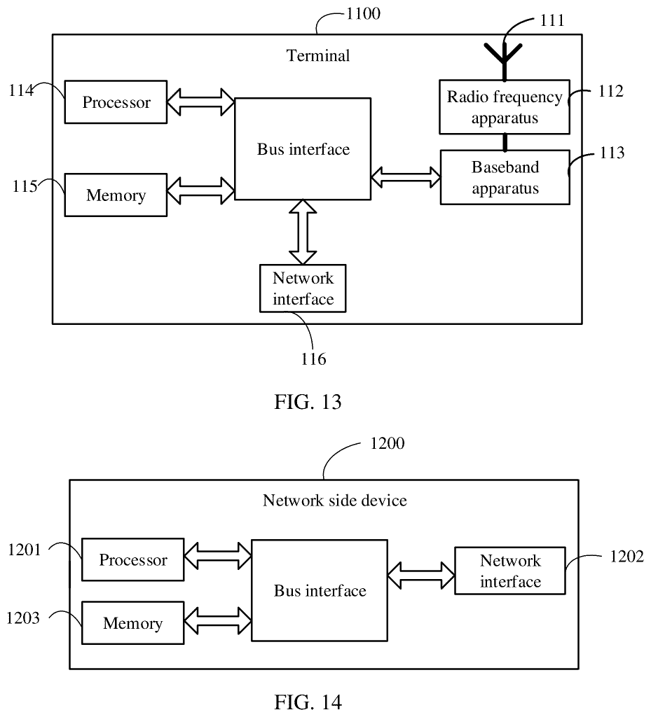

An embodiment of this application further provides a terminal. As shown in FIG. 13, the terminal 1100 includes an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111, and sends the received information to the baseband apparatus 113 for processing. In a downlink direction, the baseband apparatus 113 processes information that needs to be sent, and sends processed information to the radio frequency apparatus 112. The radio frequency apparatus 112 processes the received information, and sends processed information through the antenna 111.

In the foregoing embodiment, the data transmission method performed by the terminal may be implemented in the baseband apparatus 113. The baseband apparatus 113 includes a baseband processor.

For example, the baseband apparatus 113 may include at least one baseband board. A plurality of chips are disposed on the baseband board. As shown in FIG. 13, one chip is, for example, the baseband processor, and is connected to the memory 115 through a bus interface, to invoke a program in the memory 115 to perform the operations of the terminal shown in the embodiment of the data transmission method according to the first aspect or the second aspect.

The terminal may further include a network interface 116, and the interface is, for example, a Common Public Radio Interface (CPRI).

Specifically, the terminal 1100 in this embodiment of the present application further includes instructions or a program that is stored in the memory 115 and that can be run on the processor 114. The processor 114 invokes the instructions or the program in the memory 115 to perform the data transmission method shown in the first aspect or the second aspect, and same technical effects are achieved. To avoid repetition, details are not described herein again.

An embodiment of this application further provides a network side device. As shown in FIG. 14, a network side device 1200 includes a processor 1201, a network interface 1202, and a memory 1203. The network interface 1202 is, for example, a common public radio interface (CPRI).

The network side device 1200 in embodiments of the present application further includes instructions or a program that is stored in the memory 1203 and that can be run on the processor 1201. The processor 1201 invokes the instructions or the program in the memory 1203 to perform the data transmission method shown in the third aspect, and same technical effects are achieved. To avoid repetition, details are not described herein again.

An embodiment of this application further provides a readable storage medium. The readable storage medium stores a program or instructions. When the program or the instructions are executed by a processor, the processes of the foregoing data transmission method embodiment are implemented, and a same technical effect can be achieved. To avoid repetition, details are not described herein again.

The processor is a processor in the terminal device in the foregoing embodiment. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of this application further provides a chip. The chip includes a processor and a communication interface. The communication interface is coupled to the processor, and the processor is configured to run a program or instructions to implement the processes of the foregoing data transmission method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes in the embodiment of the data transmission method, and same technical effects can be achieved. To avoid repetition, details are not described herein again.

An embodiment of this application further provides a data transmission system. The system includes a network side device, a first terminal, and a second terminal. The first terminal is configured to perform the steps of the data transmission method according to the first aspect, the second terminal is configured to perform the steps of the data transmission method according to the second aspect, and the network side device is configured to perform the steps of the data transmission method according to the third aspect.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A method of data transmission, comprising:
receiving or generating, by a first terminal, configuration information of multi-path low-layer aggregation transmission, wherein the multi-path low-layer aggregation transmission comprises multi-path media access control (MAC) layer aggregation transmission or multi-path physical (PHY) layer aggregation transmission; and
performing, by the first terminal, the multi-path low-layer aggregation transmission based on the configuration information of multi-path low-layer aggregation transmission.

2. The method according to claim 1, wherein the receiving, by a first terminal, configuration information of multi-path low-layer aggregation transmission comprises:
receiving, by the first terminal, the configuration information of multi-path low-layer aggregation transmission that is sent by a network side device; or
receiving, by the first terminal, the configuration information of multi-path low-layer aggregation transmission that is sent by a second terminal or a third terminal,
wherein the second terminal is a relay terminal between the first terminal and the network side device, or the second terminal is a relay terminal between the first terminal and the third terminal.

3. The method according to claim 1, further comprising at least one of the following:
sending, by the first terminal, first indication information, wherein the first indication information is used to indicate whether the first terminal supports multi-path low-layer aggregation transmission; or
sending, by the first terminal, backhaul information, wherein the backhaul information is used to indicate a backhaul condition between the first terminal and the second terminal.

4. The method according to claim 1, wherein the configuration information of multi-path low-layer aggregation transmission comprises at least one of the following:
a logical architecture related to multi-path MAC layer aggregation transmission;
a logical architecture related to multi-path PHY layer aggregation transmission;
information used to indicate to perform split transmission;
information used to indicate to perform duplication transmission, information used to indicate to perform duplication transmission using a same resource, or information used to indicate to perform duplication transmission using different resources;
a data type applicable to multi-path MAC layer aggregation transmission or multi-path PHY layer aggregation transmission;
a transmission direction applicable to multi-path low-layer aggregation transmission; or
information related to the second terminal replacing the first terminal to send uplink data or an uplink feedback.

5. The method according to claim 1, further comprises at least one of the following:
sending, by the first terminal, second indication information to a network side device, wherein the second indication information is used to indicate that a multi-path low-layer aggregation transmission capability of the first terminal is limited; or
sending, by the first terminal, changed backhaul information.

6. The method according to claim 1, further comprising:
receiving or generating, by the first terminal, configuration update information of multi-path low-layer aggregation transmission; and
stopping, by the first terminal, multi-path low-layer aggregation transmission based on the configuration update information of multi-path low-layer aggregation transmission.

7. The method according to claim 1, further comprising:
determining, by the first terminal, whether a mode of multi-path low-layer aggregation transmission is a split transmission mode or a duplication transmission mode, based on at least one of the following control signaling:
radio resource control (RRC) signaling, wherein content of the RRC signaling is RRC configuration information or RRC reconfiguration information;
L1 signaling or L2 signaling used to indicate to perform switching between the split transmission mode and the duplication transmission mode; or L1 signaling used to indicate a mode of each time of multi-path low-layer aggregation transmission.

8. A method of data transmission, comprising:
receiving or generating, by a second terminal, configuration information of multi-path low-layer aggregation transmission, wherein the multi-path low-layer aggregation transmission comprises multi-path media access control (MAC) layer aggregation transmission or multi-path physical (PHY) layer aggregation transmission; and
performing, by the second terminal, the multi-path low-layer aggregation transmission based on the configuration information of multi-path low-layer aggregation transmission,
wherein the second terminal is a relay terminal between a first terminal and a network side device, or the second terminal is a relay terminal between the first terminal and a third terminal.

9. The method according to claim 8, wherein the receiving, by a second terminal, configuration information of multi-path low-layer aggregation transmission comprises:
receiving, by the second terminal, the configuration information of multi-path low-layer aggregation transmission that is sent by the network side device; or
receiving, by the second terminal, the configuration information of multi-path low-layer aggregation transmission that is sent by the first terminal or the third terminal.

10. The method according to claim 8, wherein the method further comprises at least one of the following:
sending, by the second terminal, first indication information, wherein the first indication information is used to indicate whether the second terminal supports multi-path low-layer aggregation transmission; or
sending, by the second terminal, backhaul information, wherein the backhaul information is used to indicate a backhaul condition between the second terminal and the first terminal.

11. The method according to claim 8, wherein the configuration information of multi-path low-layer aggregation transmission comprises at least one of the following:
a logical architecture related to multi-path MAC layer aggregation transmission;
a logical architecture related to multi-path PHY layer aggregation transmission;
information used to indicate to perform split transmission;
information used to indicate to perform duplication transmission, information used to indicate to perform duplication transmission using a same resource, or information used to indicate to perform duplication transmission using different resources;
a data type applicable to multi-path MAC layer aggregation transmission or multi-path PHY layer aggregation transmission;
a transmission direction applicable to multi-path low-layer aggregation transmission; or
information related to the second terminal replacing the first terminal to send uplink data or an uplink feedback.

12. The method according to claim 8, further comprising at least one of the following:
sending, by the second terminal, second indication information to the network side device, wherein the second indication information is used to indicate that a multi-path low-layer aggregation transmission capability of the second terminal is limited; or
sending, by the second terminal, changed backhaul information.

13. The method according to claim 8, further comprising:
receiving or generating, by the second terminal, configuration update information of multi-path low-layer aggregation transmission; and
stopping, by the second terminal, multi-path low-layer aggregation transmission based on the configuration update information of multi-path low-layer aggregation transmission.

14. The method according to claim 8, further comprising:
determining, by the second terminal, whether a mode of multi-path low-layer aggregation transmission is a split transmission mode or a duplication transmission mode, based on at least one of the following control signaling:
radio resource control (RRC) signaling, wherein content of the RRC signaling is RRC configuration information or RRC reconfiguration information;
L1 signaling or L2 signaling used to indicate to perform switching between the split transmission mode and the duplication transmission mode; or
L1 signaling used to indicate a mode of each time of multi-path low-layer aggregation transmission.

15. A method of data transmission, comprising:
sending, by a network side device, configuration information of multi-path low-layer aggregation transmission, wherein the multi-path low-layer aggregation transmission comprises multi-path media access control (MAC) layer aggregation transmission or multi-path physical (PHY) layer aggregation transmission; and
combining, by the network side device, different received data, or deleting duplicated received data.

16. The method according to claim 15, further comprising:
receiving, by the network side device, first indication information sent by a terminal, wherein the first indication information is used to indicate whether the terminal supports multi-path low-layer aggregation transmission; and
receiving, by the network side device, backhaul information sent by the terminal, wherein the backhaul information is used to indicate a backhaul condition between terminals.

17. The method according to claim 15, wherein the configuration information of multi-path low-layer aggregation transmission comprises at least one of the following:
a logical architecture related to multi-path MAC layer aggregation transmission;
a logical architecture related to multi-path PHY layer aggregation transmission;
information used to indicate to perform split transmission;
information used to indicate to perform duplication transmission, information used to indicate to perform duplication transmission using a same resource, or information used to indicate to perform duplication transmission using different resources;
a data type applicable to multi-path MAC layer aggregation transmission or multi-path PHY layer aggregation transmission;
a transmission direction applicable to multi-path low-layer aggregation transmission; or
information related to a second terminal replacing a first terminal to send uplink data or an uplink feedback.

18. The method according to claim 15, further comprising:
receiving, by the network side device, second indication information or changed backhaul information sent by the terminal, wherein the second indication information is used to indicate that a multi-path low-layer aggregation transmission capability of the terminal is limited; and
sending, by the network side device, configuration update information of multi-path low-layer aggregation transmission to the terminal, wherein the configuration update information of multi-path low-layer aggregation transmission is used to indicate the terminal to stop multi-path low-layer aggregation transmission; or
further comprising:
sending, by the network side device, at least one of the following control signaling to the terminal:
radio resource control (RRC) signaling, wherein content of the RRC signaling is RRC configuration information or RRC reconfiguration information;
L1 signaling or L2 signaling used to indicate to perform switching between the split transmission mode and the duplication transmission mode; or
L1 signaling used to indicate a mode of each time of multi-path low-layer aggregation transmission,
wherein the control signaling is used to indicate whether a mode of multi-path low-layer aggregation transmission is a split transmission mode or a duplication transmission mode.

19. A terminal, comprising a processor and a memory storing a program or an instruction that is capable of running on the processor, wherein the program or the instruction, when executed by the processor, causes the electronic device to perform the method according to claim 1.

20. A terminal, comprising a processor and a memory storing a program or an instruction that is capable of running on the processor, wherein the program or the instruction, when executed by the processor, causes the electronic device to perform the method according to claim 8.
